(19) United States
(12) Patent Application Publication
(10) Pub. No.: US 2025/0105539 A1
(43) Pub. Date: Mar. 27, 2025

(54) CONNECTOR CURRENT CAPACITY ADJUSTMENT METHOD, CONNECTOR, AND CONNECTOR CABLE

(71) Applicant: Japan Aviation Electronics Industry, Limited, Tokyo (JP)

(72) Inventors: Yukitaka TANAKA, Tokyo (JP); Gota KAMEYAMA, Tokyo (JP); Yukiko SATO, Tokyo (JP)

(21) Appl. No.: 18/832,090

(22) PCT Filed: Nov. 11, 2022
(86) PCT No.: PCT/JP2022/042059

§ 371 Date: Jul. 22, 2024

(30) Foreign Application Priority Data
Apr. 8, 2022 (JP) 2022-064706

(51) Int. Cl. H01R 12/75; H01R 13/24; H01R 13/506

(52) U.S. Cl. CPC H01R 12/75; H01R 13/2442; H01R 13/506

(57) ABSTRACT

A connector includes a housing and a plurality of contacts coupled with each other through at least one coupling portion, each of the plurality of contacts includes a contact portion having a spring property for making contact with an object to be connected, and a connection portion for connecting a cable without a spring property, the plurality of contacts includes signal contacts and power supply contacts, the contact portion in each of the signal contacts and the power supply contacts has a width equal to each other, and the coupling portion couples all or some of the plurality of power supply contacts at points other than the contact portions in the power supply contacts. A current capacity adjustment method for the connector includes a step of changing the number of the coupling portions that couples the power supply contacts while keeping the shapes of the contact portions.

### TECHNICAL FIELD

The present invention relates to a connector current capacity adjustment method, a connector, and a connector cable.

### BACKGROUND ART

A compression type connector that is pressed against and connected to an object to be connected has been publicly known. The structure of such a connector is disclosed in, for example, Patent Literature 1 below. As illustrated in FIG. 24, the compression type connector of the related art disclosed in Patent Literature 1 is configured as an electric connector (1) including contacts (20) having elastic spring portions (23). In the electric connector (1), the plurality of contacts (20) is arranged in order.

The contact (20) includes a substrate connection portion (22) that is soldered on a first circuit board (30) and a contact portion (24) in contact with a second circuit board (40). The elastic spring portion (23) having a spring property is provided between the substrate connection portion (22) and the contact portion (24). The second circuit board (40) is pressed from above the contact (20) attached onto the first circuit board (30) by solder connection, so that the elastic spring portion (23) of the contact (20) exerts the spring property to generate a contact pressure between the second circuit board (40) and the contact (20).

Reference numerals for the description of the patent literature are parenthesized to be distinguished from the embodiment of the invention.

### CITATION LIST

### Patent Literature

Patent Literature 1: Japanese Patent Laid-Open No. 2000-12123

### SUMMARY OF INVENTION

### Technical Problem

However, in a compression type connector of the related art example in which the plurality of contacts is arranged in order, it is difficult to adjust only a current capacity of a power supply contact while keeping the connection reliability of the connector. In other words, if the width of the power supply contact is made larger than the width of a signal contact in order to increase the current capacity of the power supply contact in the compression type connector of the related art, the spring property of the power supply contact changes to increase the hardness of a spring, thereby applying a larger pressing force to an object to be connected. In this case, the power supply contact is likely to deteriorate and the signal contact and the power supply contact have different spring properties. Thus, an uneven force is applied to an object to be connected, thereby reducing the connection reliability. In other words, in the compression type connector of the related art, the power supply contact cannot increase the current capacity and keep the same spring property as the signal contact at the same time. Particularly in the compression type connector, the contact portions of a plurality of contacts don't press opposing contacts, each one of which is independent, but press a continuous conductor such as a substrate, so that an uneven pressing force may seriously reduce the connection reliability.

Thus, an object of the present invention is to provide a compression type connector with a plurality of contacts arranged in order, the connector being cable of adjusting only the current capacity of a power supply contact while keeping the connection reliability of the connector, and a current capacity adjustment method for the connector.

### Solution to Problem

A connector current capacity adjustment method according to the present invention is a method used for a compression type connector that is pressed against and connected to an object to be connected, wherein the connector includes a housing made of resin, and a plurality of contacts arranged in order while being partially embedded in the housing, each of the plurality of contacts includes a contact portion having a spring property for making contact with the object to be connected, and a connection portion having no spring property for connecting a cable, the plurality of contacts includes a plurality of signal contacts used for signal transmission and a plurality of power supply contacts used for power supply, the contact portion being formed with an identical width in the plurality of signal contacts and the plurality of power supply contacts, a coupling portion that couples the power supply contacts is allowed to be formed in all or some of the plurality of power supply contacts, and a current capacity is adjusted with the maintained spring property of the power supply contact by changing the number of the coupling portions that couple the power supply contacts while keeping the shapes of the contact portions having a spring property in the plurality of power supply contacts.

A connector according to the present invention is a compression type connector that is pressed against and connected to an object to be connected, wherein the connector includes a housing made of resin, and a plurality of contacts arranged in order while being partially embedded in the housing, each of the plurality of contacts includes a contact portion having a spring property for making contact with the object to be connected, and a connection portion for connecting a cable without a spring property, the plurality of contacts includes a plurality of signal contacts used for signal transmission and a plurality of power supply contacts used for power supply, the contact portion being formed with an identical width in the plurality of signal contacts and the plurality of power supply contacts, a coupling portion that couples the power supply contacts is formed in all or some of the plurality of power supply contacts, and the coupling portion couples the power supply contacts at points other than the contact portions while keeping shapes of the contact portions having a spring property in the plurality of power supply contacts.

In the connector according to the present invention, the coupling portion can couple only the connection portions having no spring property while keeping the shapes of the contact portions having a spring property in the plurality of power supply contacts.

In the connector according to the present invention, the plurality of contacts can include a plurality of contact groups that vary in the number of the coupling portions coupling only the connection portions having no spring property while keeping the shapes of the contact portions having a spring property.

In the connector according to the present invention, the contact portions having a spring property for making contact with the object to be connected can be all identical in shape.

In other words, the spring property of the contact according to the present invention is determined by the shape of the contact portion having a spring property and is not affected by other shapes (for example, the shape of the connection portion having no spring property). Moreover, the power supply contacts and the signal contacts have contact portions identical in width, which indicates that each of the contact portions has the same spring property and current capacity because the contact portions have identical cross-sectional shapes.

Furthermore, only the connection portions of the power supply contacts are coupled while keeping the shapes of the contact portions arranged in order, thereby increasing the current capacity of the power supply contact while keeping the same spring properties of the power supply contacts and the signal contacts. In other words, in the contact of the present invention, the contact portions of the power supply contact and the signal contact have the same spring property, so that a force is evenly applied to an object to be connected.

The present invention includes a connector cable having a plurality of cables connected to the connection portions of the plurality of contacts provided in the foregoing connector.

In the connector cable of the present invention, among the plurality of cables, signal cables connected to the signal contacts and power cables connected to the power supply contacts can have different appearances.

In a connector current capacity adjustment method according to the present invention, each of the plurality of contacts includes a noncontact portion instead of the connection portion, the noncontact portion not connecting a cable and having no spring property, and a current capacity can be adjusted with the maintained spring property of the power supply contact by changing the number of the coupling portions that couple the noncontact portions in the plurality of power supply contacts.

In a connector according to the present invention, each of the plurality of contacts includes a noncontact portion instead of the connection portion, the noncontact portion not connecting a cable and having no spring property, and the coupling portion couples the noncontact portions of the adjacent power supply contacts while keeping the shapes of the contact portions having a spring property in the plurality of power supply contacts.

### Advantageous Effect of Invention

According to the present invention, a spring property at the contact portion between the power supply contact and the signal contact, that is, a pressing force to an object to be connected can be made uniform while the current capacity of the power supply contact is increased. In other words, the present invention provides a connector that adjusts only the current capacity of a power supply contact while keeping the connection reliability of the connector, and a current capacity adjustment method for the connector.

### BRIEF DESCRIPTION OF DRAWINGS

FIG. 1 is an outside perspective view of a connector cable according to the present embodiment when the connector cable is viewed diagonally from the upper right of the front.

FIG. 2 is an outside perspective view of the connector cable according to the present embodiment when the connector cable is viewed diagonally from the lower right of the front.

FIG. 3 is a right side view of the connector cable according to the present embodiment.

FIG. 4 is a right side view illustrating a usage state of the connector cable according to the present embodiment.

FIG. 5 is an exploded perspective view for describing the configuration of the connector cable according to the present embodiment.

FIG. 6 is a top view illustrating a housing, a plurality of contacts, and cables from among the components of the connector cable according to the present embodiment.

FIG. 7 is a top view illustrating the housing and the plurality of contacts from among the components of the connector cable according to the present embodiment.

FIG. 8 is a cross-sectional view showing a cross section at a point indicated by a line of reference character A-A in FIG. 7.

FIG. 9 illustrates the housing and the plurality of contacts from among the components of the connector cable according to the present embodiment, drawing (a) in FIG. 9 illustrates an appearance when viewed diagonally from the upper right of the front, and drawing (b) illustrates an appearance when viewed diagonally from the upper left of the back.

FIG. 10 illustrates a disassembled state of the housing and the plurality of contacts in FIG. 9, and drawings (a) and (b) in FIG. 10 correspond to the drawings in FIG. 9.

FIG. 11 is an explanatory drawing of the shape of a contact according to the present embodiment, drawing (a) in FIG. 11 is a right side view, drawing (b) illustrates an appearance when viewed diagonally from the upper right of the front, and drawing (c) illustrates an appearance when viewed diagonally from the lower right of the front.

FIG. 12 is an explanatory drawing of the shape of a contact group according to the present embodiment, drawing (a) in FIG. 12 is a top view, drawing (b) illustrates an appearance when viewed diagonally from the upper right of the front, and drawing (c) illustrates an appearance when viewed diagonally from the lower right of the front.

FIG. 13 is a top view illustrating the housing and the plurality of contacts from among the components of the connector cable, drawing (a) in FIG. 13 illustrates the configuration of the present embodiment, and drawing (b) illustrates the configuration of the comparative example.

FIG. 14 illustrates a state in which cables are mounted on the housing and the plurality of contacts that constitute the connector cable in FIG. 13, and drawings (a) and (b) in FIG. 14 correspond to the drawings in FIG. 13.

FIG. 15 is an explanatory drawing of a method for manufacturing the contacts and the contact group according to the present embodiment.

FIG. 16 is an explanatory drawing of the method for manufacturing the contacts and the contact group according to the present embodiment.

FIG. 17 is an explanatory drawing of the method for manufacturing the contacts according to the present embodiment.

FIG. 18 illustrates a modification example that can be set for a contact group according to the present invention, drawing (a) in FIG. 18 is a top view, drawing (b) illustrates an appearance when viewed diagonally from the upper right of the front, and drawing (c) illustrates an appearance when viewed diagonally from the lower right of the front.

FIG. 19 illustrates another modification example that can be set for the contact group according to the present invention, drawing (a) in FIG. 19 is a top view, and drawing (b) illustrates an appearance when viewed diagonally from the upper left of the back.

FIG. 20 illustrates a modification example that can be set for the contact according to the present invention, drawing (a) in FIG. 20 is a right side view, drawing (b) illustrates an appearance when viewed diagonally from the upper right of the front, and drawing (c) illustrates an appearance when viewed diagonally from the lower right of the front.

FIG. 21 illustrates a configuration example of the contact groups that the contacts in FIG. 20 are coupled, drawing (a) in FIG. 21 is a top view, drawing (b) illustrates an appearance when viewed diagonally from the upper right of the front, and drawing (c) illustrates an appearance when viewed diagonally from the lower right of the front.

FIG. 22 illustrates another modification example that can be set for the contact according to the present invention, drawing (a) in FIG. 22 is a right side view, drawing (b) illustrates an appearance when viewed diagonally from the upper right of the front, and drawing (c) illustrates an appearance when viewed diagonally from the lower right of the front.

FIG. 23 illustrates a configuration example of the contact groups that the contacts in FIG. 22 are coupled, drawing (a) in FIG. 23 is a top view, drawing (b) illustrates an appearance when viewed diagonally from the upper right of the front, and drawing (c) illustrates an appearance when viewed diagonally from the lower right of the front.

FIG. 24 is a cross-sectional view illustrating a state in which a compression type connector of the related art is disposed between circuit boards.

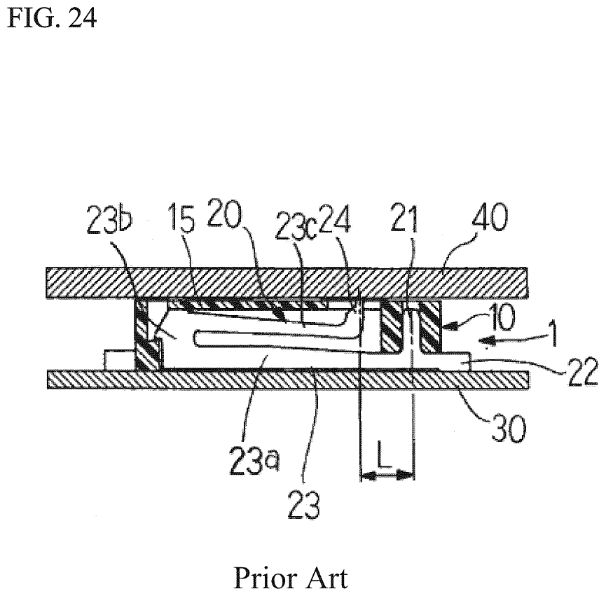

### DESCRIPTION OF EMBODIMENT

Preferred embodiments for implementing the present invention will be described below in accordance with the accompanying drawings. In the drawings, a first direction, a second direction, and a third direction are defined for convenience of description. In the present specification, the first direction is a longitudinal direction. In the drawings, the longitudinal direction is denoted as X direction. In particular, a frontward direction is denoted as +X direction while a rearward direction is denoted as −X direction. In the present specification, the second direction is a lateral direction. In the drawings, the lateral direction is denoted as Y direction. In particular, a rightward direction is denoted as +Y direction while a leftward direction is denoted as −Y direction. Furthermore, in the present specification, the third direction is a vertical direction. In the drawings, the vertical direction is denoted as Z direction. In particular, an upward direction is denoted as +Z direction while a downward direction is denoted as −Z direction. However, X direction defined as the first direction, Y direction defined as the second direction, and Z direction defined as the third direction in the present specification are not intended to limit the orientations of a connector and a connector cable in use according to the present embodiment. The connector and connector cable according to the present embodiment can be used in all directions.

The following embodiments are not intended to limit the invention according to claims. All the combinations of features described in the embodiment are not always necessary for the solution of the invention.

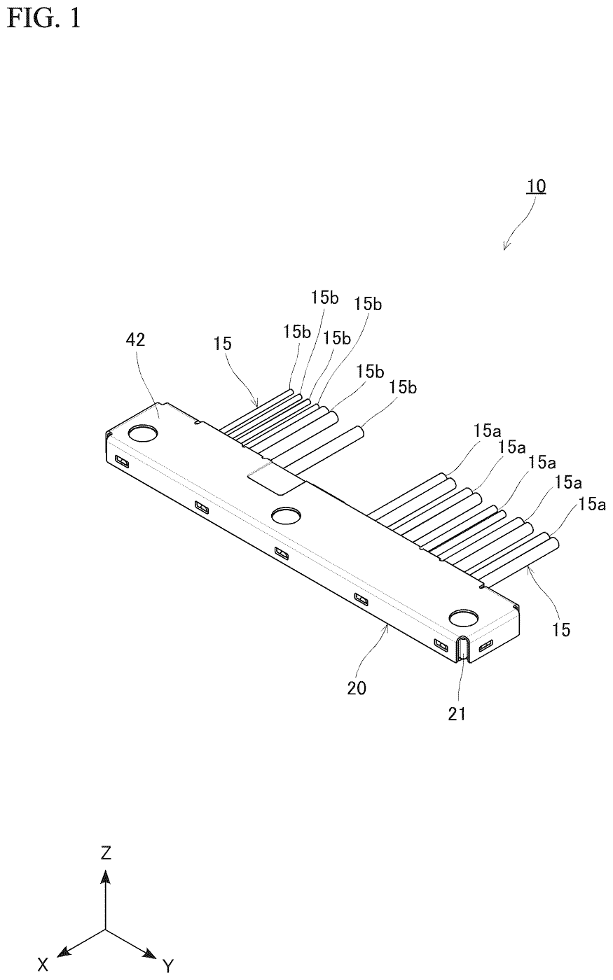

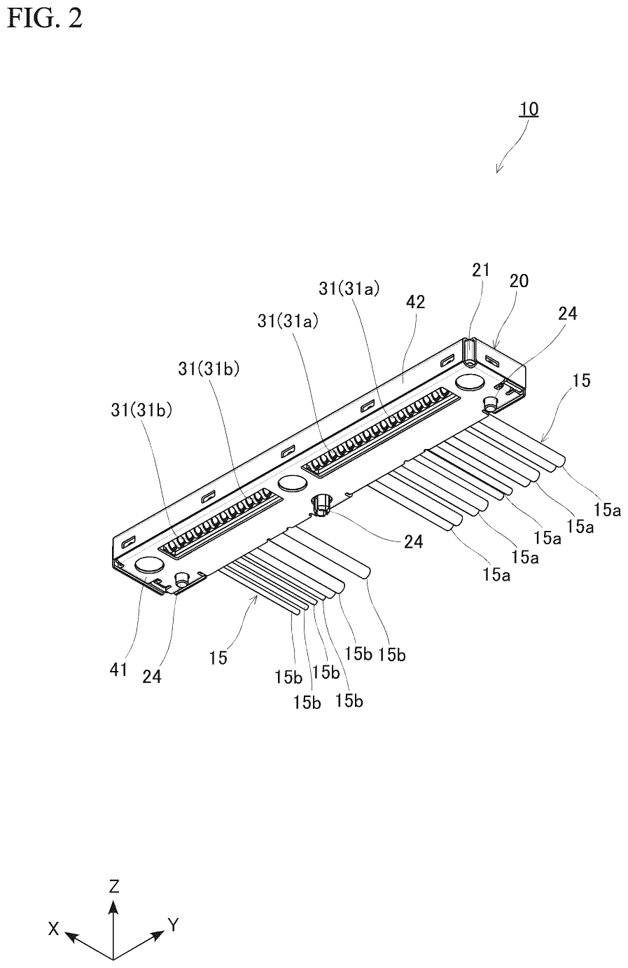

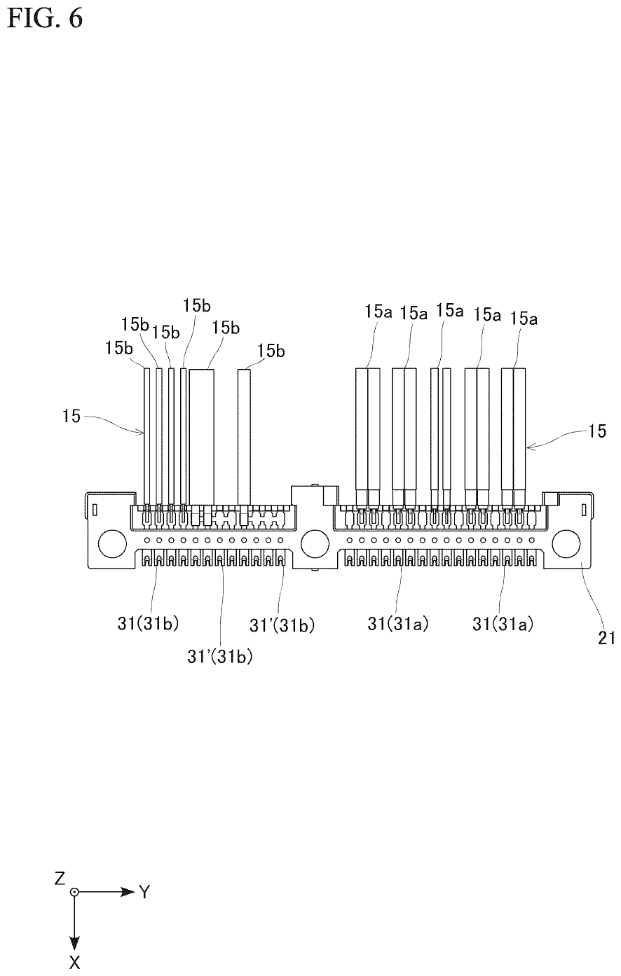

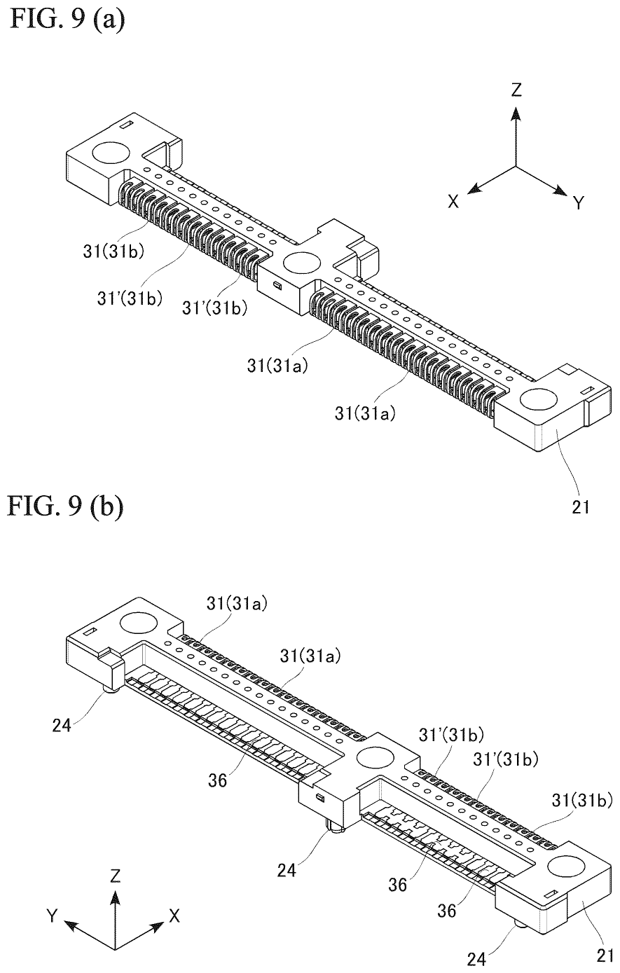

First, referring to FIGS. 1 to 10, a connector cable 10 according to the present embodiment will be described below.

The connector cable 10 according to the present embodiment includes a connector 20 substantially shaped like a rectangle extending in the lateral direction, and a plurality of cables 15 connected to the connector 20.

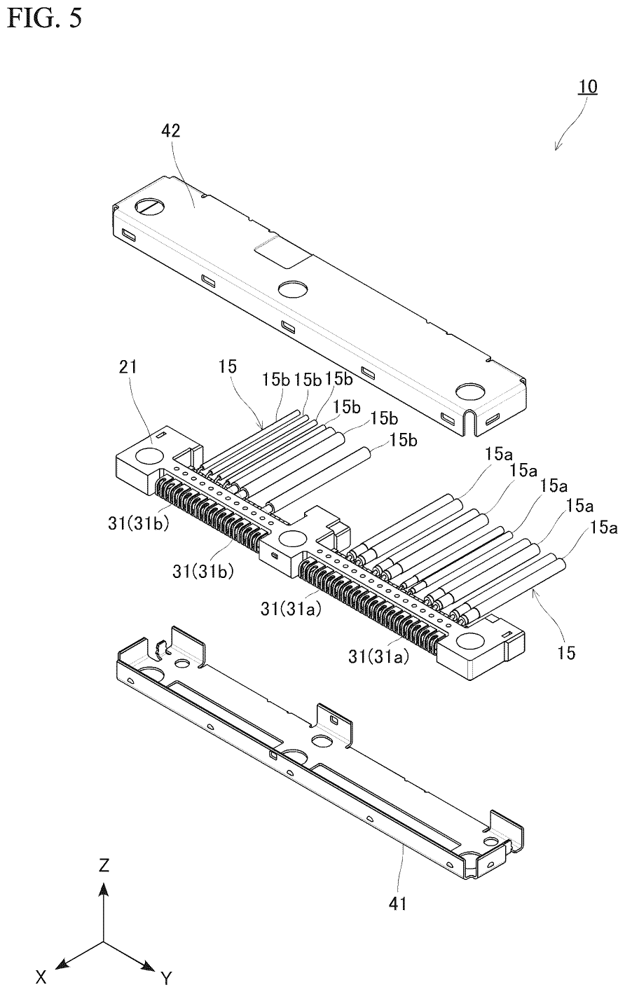

As illustrated in FIG. 5, the connector 20 includes a housing 21 made of resin and a plurality of contacts 31 arranged in order while being partially embedded in the housing 21. Moreover, a metallic shell 41 is disposed below the housing 21 with the plurality of embedded contacts 31, and a metallic cover shell 42 is disposed above the housing 21.

The shell 41 and the cover shell 42 are vertically combined while containing the housing 21, which forms the outer shell shape of the connector 20. The shell 41 and the cover shell 42 are disposed to cover the outer periphery of the housing 21 with the plurality of embedded contacts 31, thereby protecting the housing 21 with the plurality of embedded contacts 31 that receive power from the cables 15. This protection includes electric and magnetic protection such as an electromagnetic shield in addition to physical protection from an external environment.

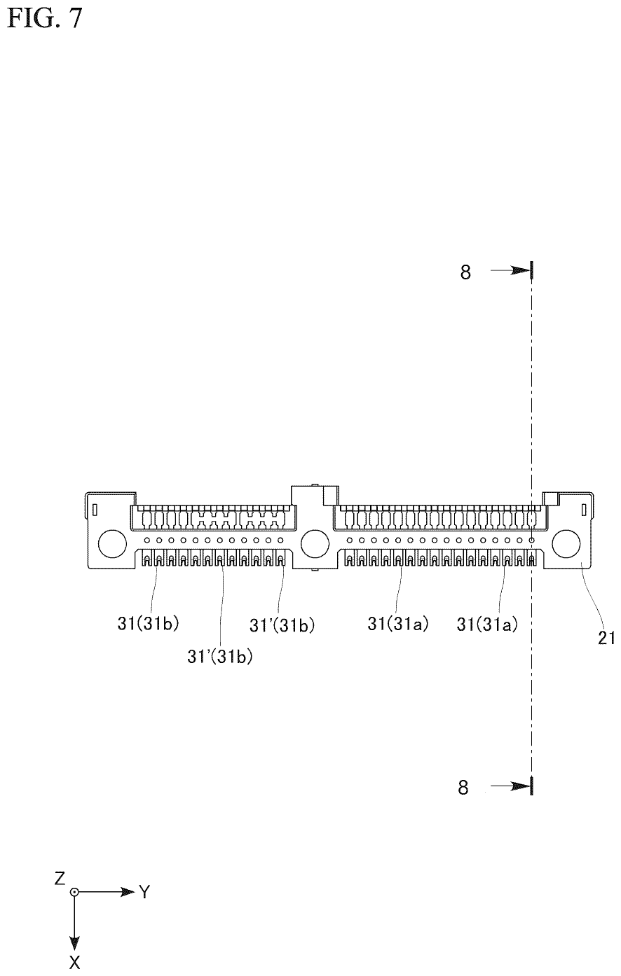

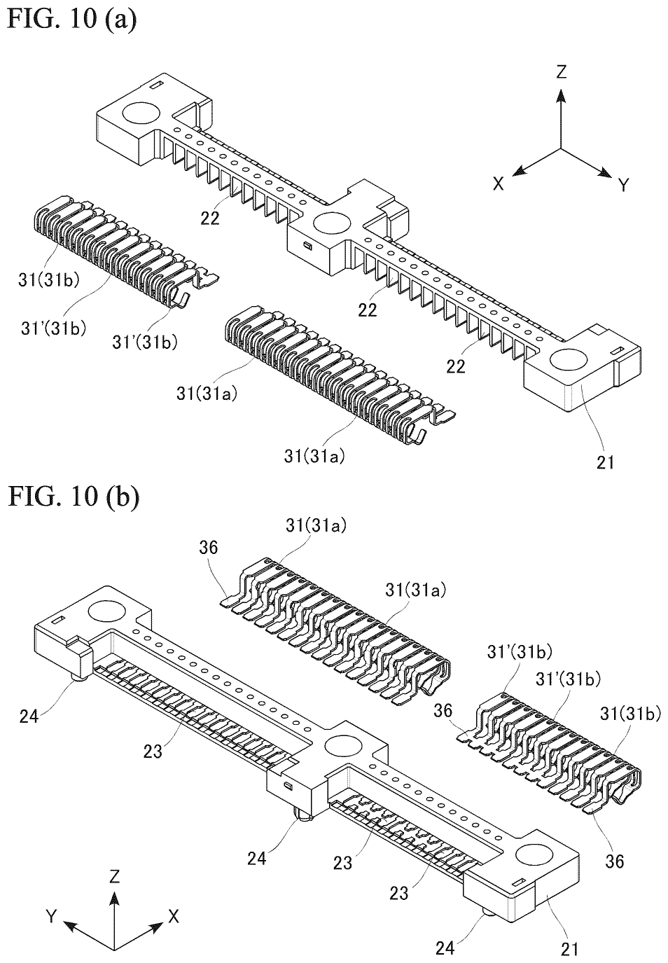

As illustrated in FIGS. 7 to 10, the plurality of contacts 31 laterally arranged in a row are embedded in the housing 21. This state is obtained by, for example, placing the plurality of contacts 31 in the cavity of a mold and injecting resin around the contacts 31 to integrally mold the housing 21 and the plurality of contacts 31. Thus, as illustrated in FIG. 10, the housing 21 as a single component has contact storage shape portions 22 for placing the plurality of contacts 31 on the front side and contact embedding grooves 23 for embedding connection portions 36 on the top surface on the rear side, the connection portions 36 being located on the rear side of the contacts 31.

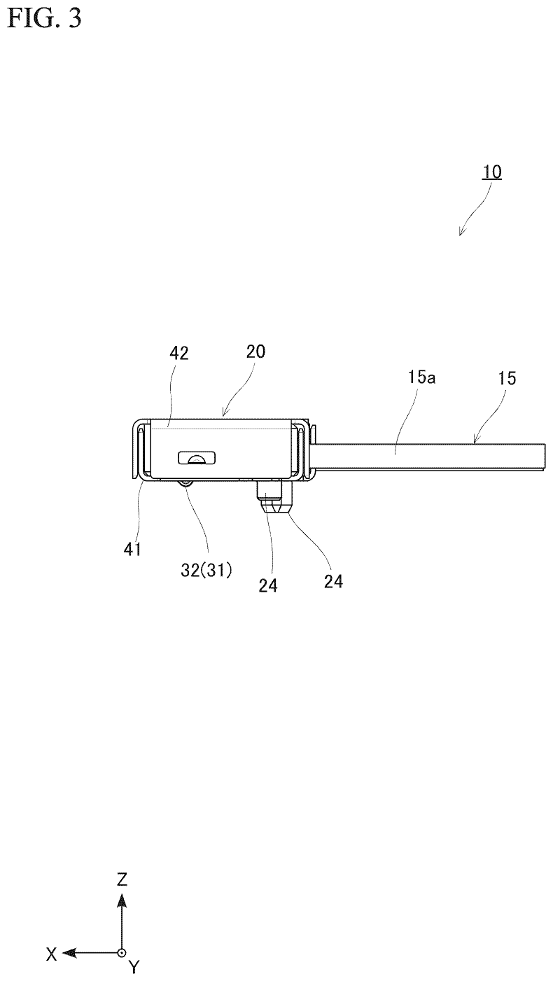

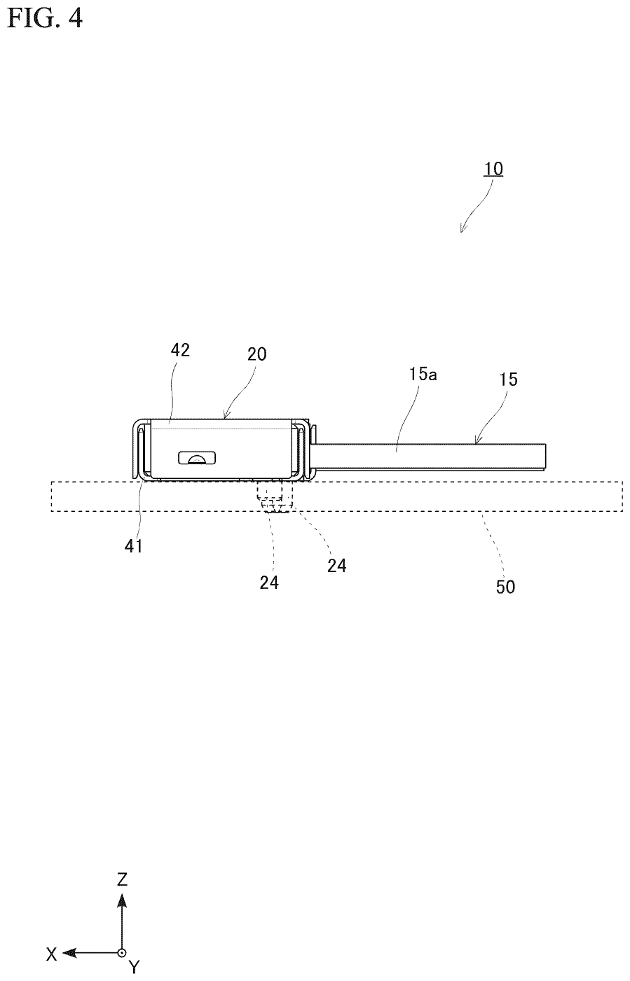

As illustrated in FIG. 3, the connector 20 obtained by the foregoing manufacturing method is disposed such that contact portions 32 as parts of the contacts 31 and mounting leg portions 24 as parts of the housing 21 protrude downward from the bottom side of the shell 41 in right side view. As illustrated in FIG. 4, when a substrate 50 as an object to be connected is pressed upward from below the connector 20, the position of the connector 20 is fixed to the substrate 50 by fitting the mounting leg portions 24 into unshown fixing holes on the substrate 50, and the contact portions 32 as parts of the contacts 31 are pressed to the top surface of the substrate 50, so that the contact portions 32 of the plurality of contacts 31 provided in the connector 20 and an unshown printed circuit formed on the substrate 50 are brought into contact with each other to make an electrical connection.

The cables 15 connected to the plurality of contacts 31 provided in the connector 20 according to the present embodiment include a plurality of signal cables 15a used for signal transmission and a plurality of power cables 15b used for power supply. The power cables 15b of the present embodiment are supposed to include ordinary power cables for supplying power to devices connected to the connector 20 and ground cables for return ground or other power cables for supplying power to other devices. In the following description, the contacts 31 connected to the signal cables 15a are referred to as signal contacts 31a while the contacts 31 connected to the power cables 15b are referred to as power supply contacts 31b. Moreover, in the present embodiment, the signal cables 15a connected to the signal contacts 31a and the power cables 15b connected to the power supply contacts 31b are formed in different appearances among the plurality of cables 15.

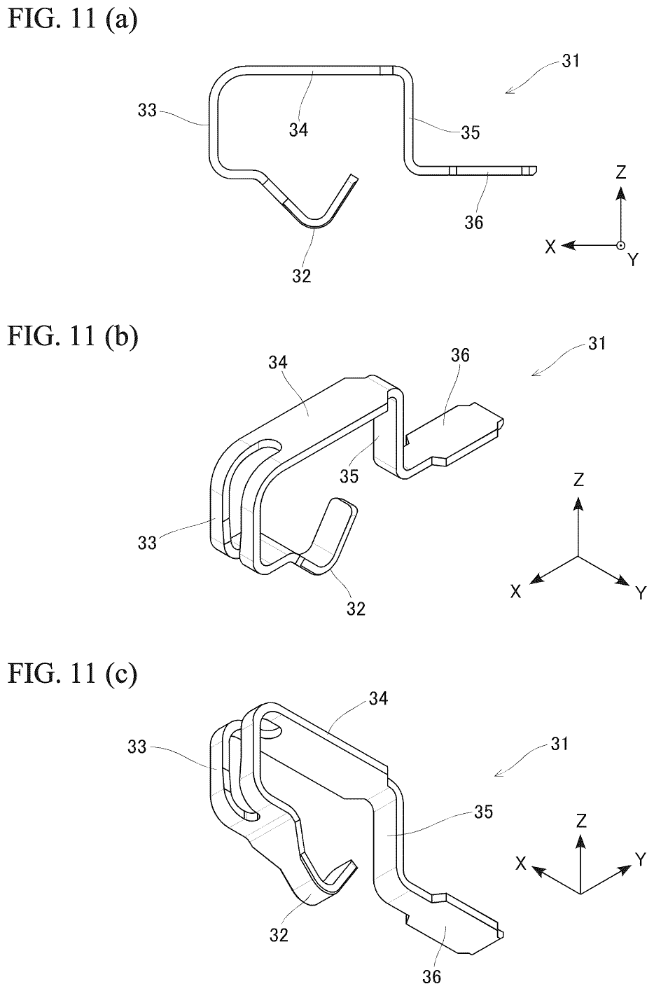

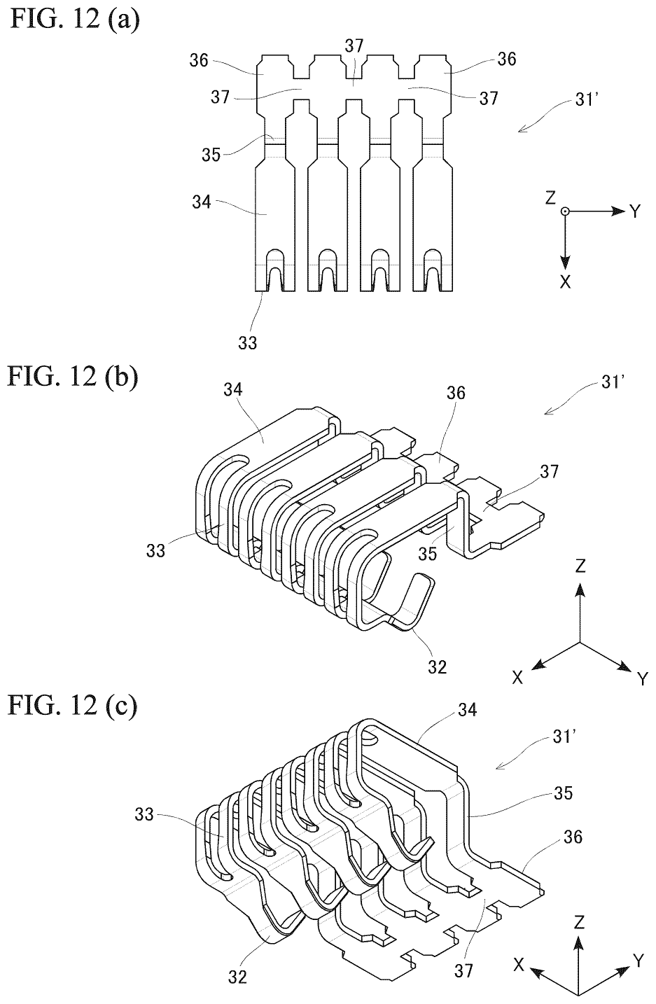

Referring to FIGS. 1 to 10, the basic configuration of the connector cable 10 according to the present embodiment was described above. Subsequently, referring to FIGS. 11 and 12, the specific shapes of the contacts 31 provided for the connector cable 10 and the connector 20 according to the present embodiment will be described below.

First, FIG. 11 shows the shape of the single contact 31. The contact 31 of the present embodiment is formed by the contact portion 32 that is located at a lower position to make contact with the substrate 50 serving as an object to be connected, a spring shape portion 33 that is connected to the front of the contact portion 32 and is curved substantially in the form of a letter C in the front of the contact 31 in right side view, a horizontal support portion 34 that is connected to the upper side of the spring shape portion 33 and is formed to extend horizontally toward the rear, a vertical fixing portion 35 that is connected to the rear end of the horizontal support portion 34, is vertically extended downward, and is embedded into the housing 21 made of resin, and the connection portion 36 that is connected to the lower end of the vertical fixing portion 35, is formed to extend horizontally to the rear, and is used for connecting the cable 15.

The contact portion 32 in contact with the substrate 50 serving as an object to be connected has a spring property due to the effect of an elastic force exerted by the spring shape portion 33. When the contact portion 32 receives an upward force from the substrate 50 serving as an object to be connected, a pressing force as a reaction force against the upward force is exerted downward, achieving a state of firm contact between the substrate 50 serving as an object to be connected and the contact portion 32.

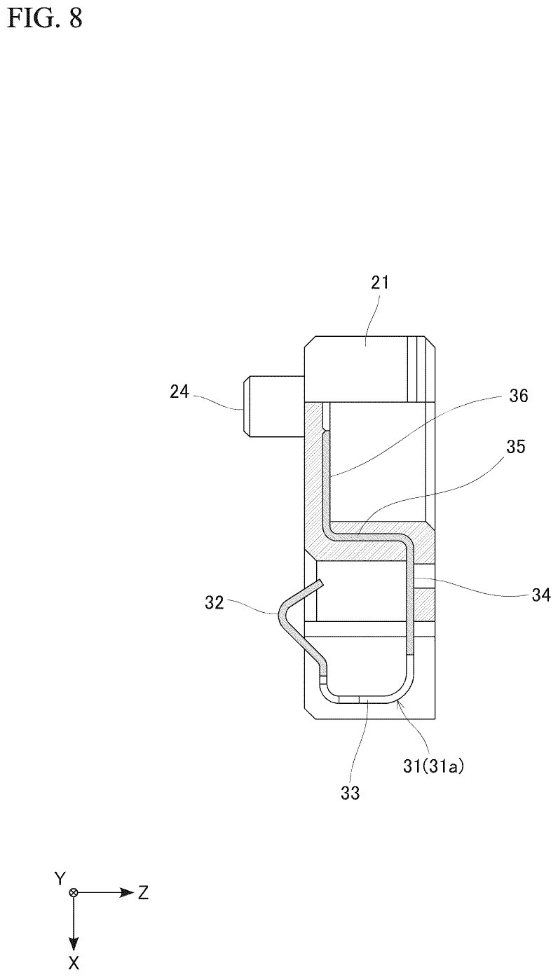

In the structure forming the contact 31, as illustrated in FIG. 8, the positions of the horizontal support portion 34, the vertical fixing portion 35, and the connection portion 36 are fixed by the resin housing 21, so that these portions do not exert a spring property even when receiving an external force.

For the single contact 31 in FIG. 11, a coupling portion 37 is formed to couple the plurality of adjacent contacts 31 as illustrated in FIG. 12, thereby forming the contacts 31 as a contact group 31′. In the present embodiment, the four contacts 31 are coupled by the three coupling portions 37. In the contact group 31′ of the present embodiment, the coupling portion 37 is formed to connect to the connection portion 36 having no spring property and only the connection portions 36 of the plurality of adjacent contacts 31 are coupled to each other. In other words, for the contact group 31′ of the present embodiment, a configuration is adopted to couple only the connection portions 36 having no spring property while keeping the shapes of the contact portions 32 having a spring property between the plurality of adjacent contacts 31. Thus, the contact portions 32 having a spring property exert the same spring property in all the contacts 31 constituting the contact group 31′ and the contacts 31 not constituting the contact group 31′, so that the connector can be configured to adjust only the current capacity of the contact 31 while keeping the connection reliability of the connector.

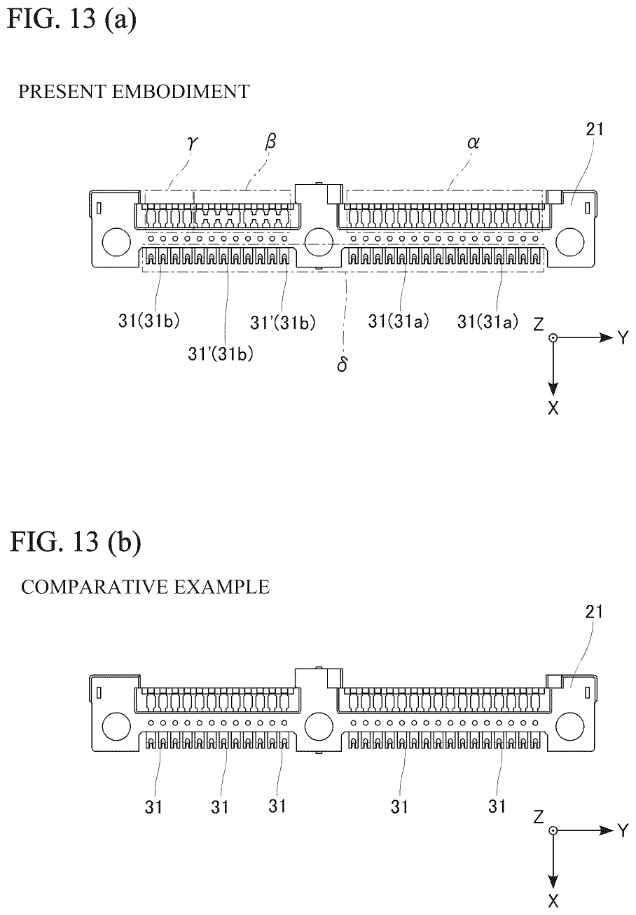

As illustrated in drawing (a) in FIG. 13, in the present embodiment, the plurality of single contacts 31 are disposed in chain-line regions indicated by reference character α and reference character γ, and the two contact groups 31′ are disposed in a chain-line region indicated by reference character β, the contact group 31′ including the four coupled contacts 31.

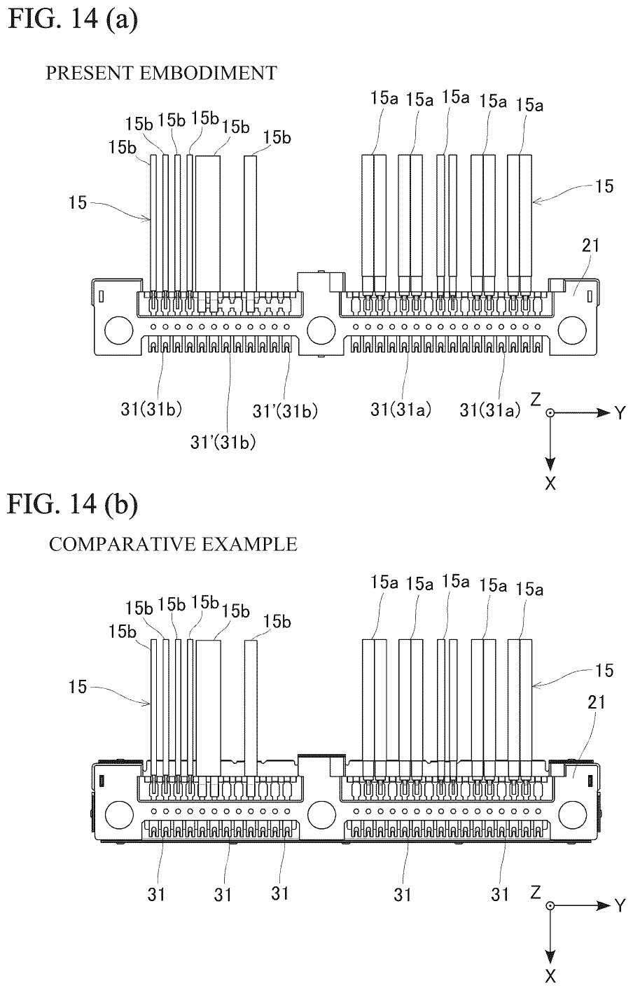

In the present embodiment, as is evident from a comparison between drawings (a) in FIGS. 13 and 14, the signal cables 15a are connected to the plurality of contacts 31 in the chain-line region indicated by reference character α while the power cables 15b are connected to the two contact groups 31′ in the chain-line region indicated by reference character β. In the present embodiment illustrated in FIG. 14, the two contact groups 31′ include the left contact group 31′ connected to the large-capacity power cable 15b and the right contact group 31′ connected to the power cable 15b for return ground. Furthermore, the plurality of contacts 31 in the chain-line region indicated by reference character γ are connected to the power cables 15b for small-capacity power supply.

As described above, in addition to a first power supply (a large-capacity power supply), when a second power supply (a small-capacity power supply for supplying power to a target different from that of the first power supply) is necessary, the return ground (hereinafter referred to as “ground”) may be shared by the first power supply and the second power supply. In this case, a current passing through the ground is the total current of the first power supply and the second power supply. Thus, the ground needs a larger current capacity and may have a larger number of coupled contacts than the first (or second) power supply. However, if the first (second) power supply and the ground have current capacities in the same range, the first (or second) power supply and the ground may have the same number of coupled contacts. For example, if the contacts 31 each have a current capacity of 2 A, the first power supply has a current of 4.5 A, and the second power supply has a current of 1 A, the current of the ground is expressed as 4.5 A+1 A=5.5 A, so that the currents of the first power supply and the ground can be supplied by coupling the three contacts (up to 2 A×3 contacts=6 A).

If the foregoing contents are applied to the present embodiment, the first power supply as a large-capacity power supply and the power supply for return ground are connected to the contact group 31′ via the power cables 15b, so that the power cables 15b are connected to the contact group 31′ having a current capacity equivalent to the current capacity of the four contacts 31. The contact portions 32, which are disposed with a spring property in a chain-line region indicated by reference character δ in drawing (a) in FIG. 13, are identical in shape in the contact group 31′ and all the single contacts 31, thereby exerting a uniform spring property.

As is evident from a comparison between drawings (b) in FIGS. 13 and 14, the connector is configured only with the single contacts 31 in the prior art in which the coupling portions 37 are not provided. Thus, it is difficult to adjust only the current capacities of the power supply contacts 31b to which the power cables 15b are connected. In other words, in the prior art described as the comparative example, it is difficult to adjust only the current capacities of the power supply contacts 31b while keeping the connection reliability of the connector. However, according to the present embodiment illustrated in drawing (a) in FIG. 13 and drawing (a) in FIG. 14, the contacts 31 and the contact group 31′ are properly disposed in the presence of the coupling portions 37, thereby simultaneously adjusting a current capacity and keeping the connection reliability of the connector 20 without the difficulty in the prior art.

The foregoing embodiment discloses the connector 20 including the two contact groups 31′, each including the four contacts 31 coupled by the three coupling portions 37. A current capacity adjustment method for the connector of the present invention is characterized in that a current capacity is adjusted with the maintained spring property of the power supply contacts 31b by changing the number of the coupling portions 37 that couple the adjacent power supply contacts 31 while keeping the shapes of the contact portions 32 having a spring property in the plurality of power supply contacts 31b. Therefore, the number of the coupling portions 37 that couple the power supply contacts 31 can be changed as appropriate, so that the number of contacts 31 constituting the contact group 31′ can be changed as appropriate. In other words, the plurality of contacts 31 can include the plurality of contact groups 31′ that vary in the number of the coupling portions 37 coupling only the connection portions 36 having no spring property while keeping the shapes of the contact portions 32 having a spring property.

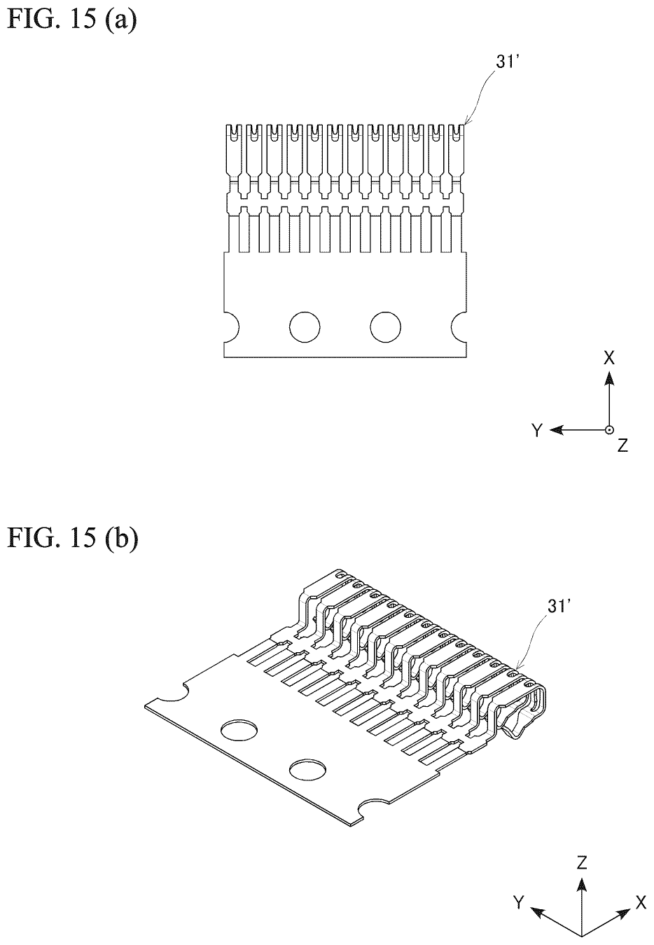

The specific shapes of the connector cable 10 and the contacts 31 provided in the connector 20 according to the present embodiment were described above. Subsequently, referring to FIGS. 15 to 17, a method for manufacturing the contacts 31 and the contact group 31′ according to the present embodiment will be described below.

In the method for manufacturing the contacts 31 and the contact group 31′ according to the present embodiment, first, a conductive metallic plate is prepared, and then the metallic plate is pressed to obtain the shape of a contact workpiece. In the stage of press working, the connection portions 36 used for connecting the cables 15 and the coupling portions 37 that couple the adjacent connection portions 36 are completely shaped. Furthermore, as illustrated in FIG. 15, the eleven coupling portions 37 are formed between the adjacent connection portions 36 so as to couple all the twelve connection portions 36. Moreover, for the vertical fixing portion 35, the horizontal support portion 34, the spring shape portion 33, and the contact portion 32 that are connected to the connection portion 36, the original shapes are stamped by press working. By bending on these portions, the vertical fixing portion 35, the horizontal support portion 34, the spring shape portion 33, and the contact portion 32 can be shaped as portions constituting the contact group 31′ illustrated in FIG. 15.

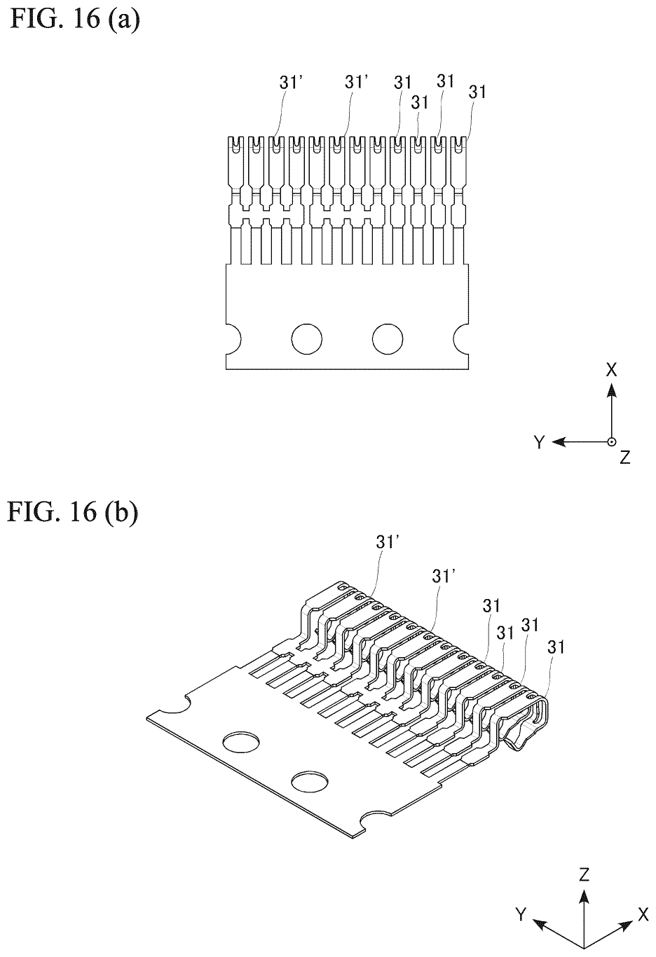

For example, as illustrated in the state of FIG. 15 and the state of FIG. 16, some of the coupling portions 37 are left while the other coupling portions 37 are cut and removed, so that the contacts 31 and the contact groups 31′ are obtained. In the example of FIG. 16, the four contacts 31 and the two contact groups 31′ are manufactured.

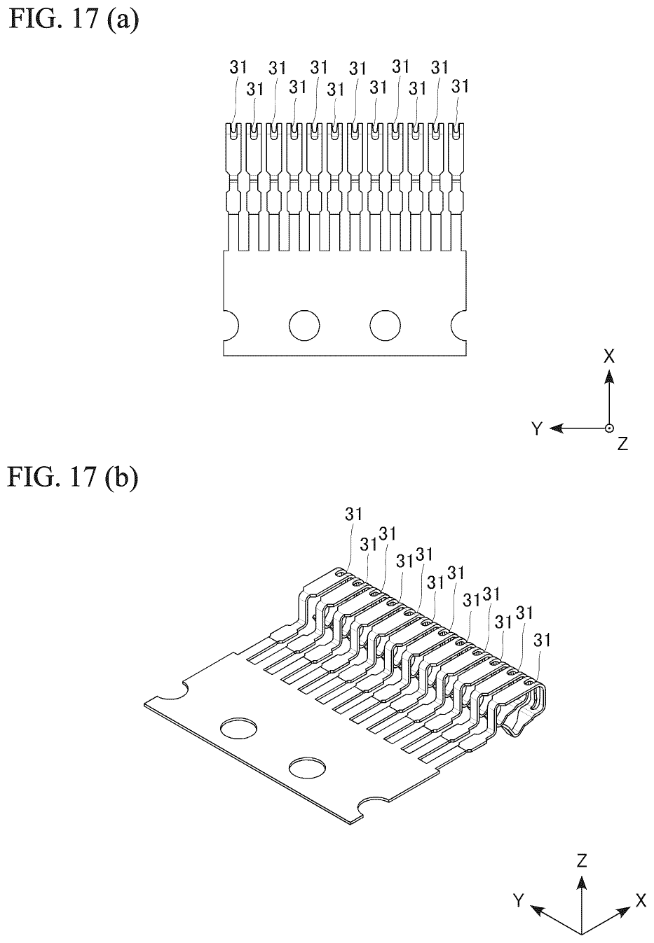

For example, as in the state of FIG. 17 from the state of FIG. 15, all the coupling portions 37 are cut and removed to obtain the plurality of contacts 31. In the example of FIG. 17, the twelve contacts 31 are manufactured.

Finally, unnecessary portions are cut and removed from the states of FIGS. 16 and 17, so that the manufacturing of the contacts 31 and the contact group 31′ according to the present embodiment is completed.

According to the method for manufacturing the contacts 31 and the contact group 31′ according to the present embodiment illustrated in FIGS. 15 to 17, the two contact shapes of the contacts 31 and the contact group 31′ can be produced without an additional manufacturing step, and only the current capacity of the contact can be adjusted, so that the connector 20 and the connector cable 10 of the present embodiment can be obtained without increasing the cost. Thus, the manufacturing method is preferable.

The preferred embodiment of the present invention was described above. The technical scope of the present invention is not limited to the scope of the embodiment. The embodiment can be changed or modified in various ways.

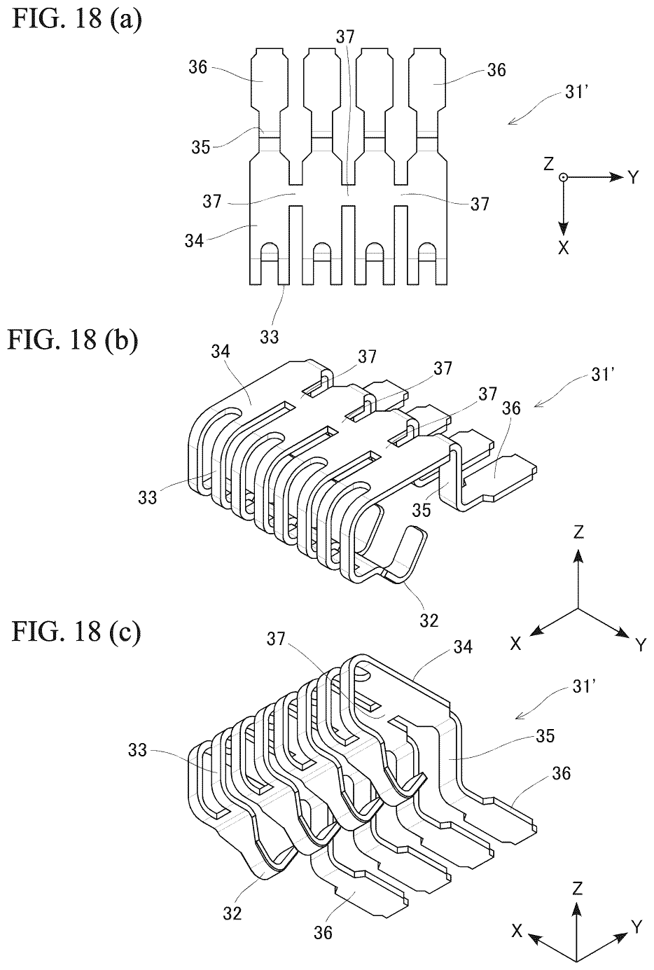

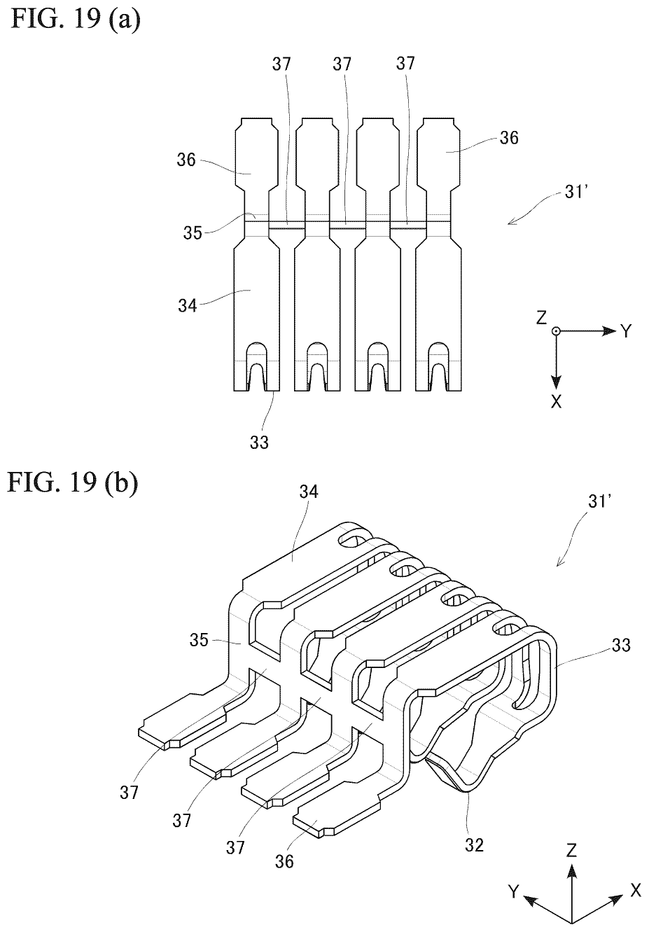

For example, the foregoing embodiment discloses a configuration example in which the contacts 31 constituting the contact group 31′ have the coupling portions 37 that couple the adjacent sides of the connection portions 36 used for connecting the cables 15. However, the scope of the present invention is not limited to the foregoing embodiment. For example, a configuration may be adopted such that the coupling portion 37 is routed behind the connection portion 36 to couple the rear end faces of the connection portions 36. The coupling portion 37 routed for coupling behind the connection portion 36 can also couple the connection portions 36 not adjacent to each other. As illustrated in FIG. 18, a configuration may be adopted such that the coupling portions 37 are provided at the points of the horizontal support portions 34, or as illustrated in FIG. 19, a configuration may be adopted such that the coupling portions 37 are provided at the points of the vertical fixing portions 35. In the case of the foregoing embodiment and the cases of FIGS. 18 and 19, the connection portion 36, the horizontal support portion 34, and the vertical fixing portion 35 where the coupling portions 37 are formed are portions having no spring property. In other words, the present invention includes a configuration in which the contact group 31′ including the plurality of coupled contacts 31 is formed by providing the coupling portions 37 coupling only portions having no spring property while keeping the shapes of the contact portions 32 having a spring property. In the contacts and the contact group according to the present invention configured thus, the contact portions having a spring property for making contact with an object to be connected can be all configured with identical shapes. In other words, according to the present invention, a spring property at the contact portion between the power supply contact and the signal contact, that is, a pressing force to an object to be connected can be made uniform while the current capacity of the power supply contact is increased.

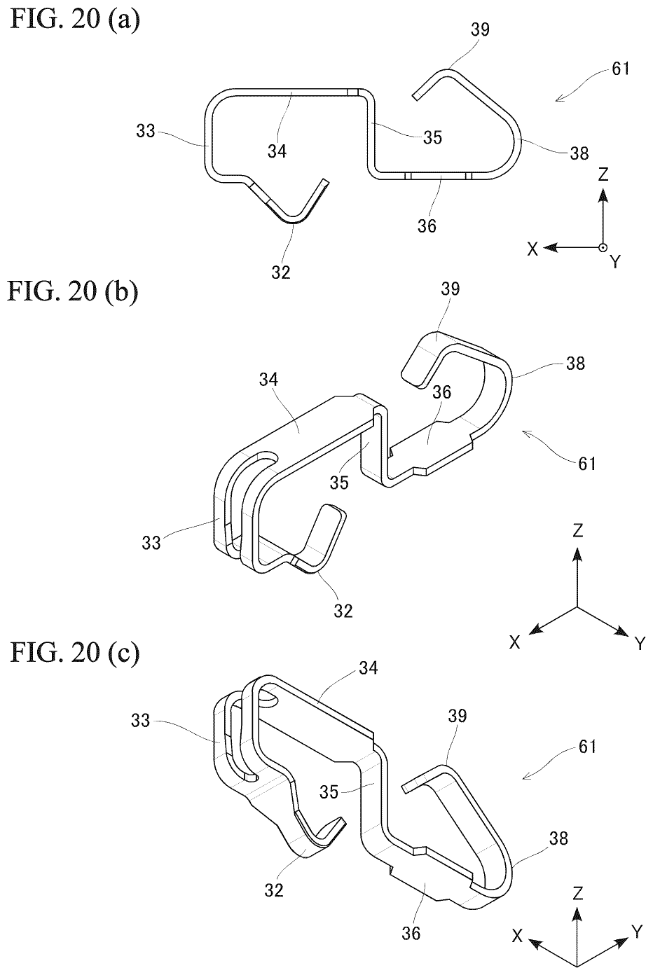

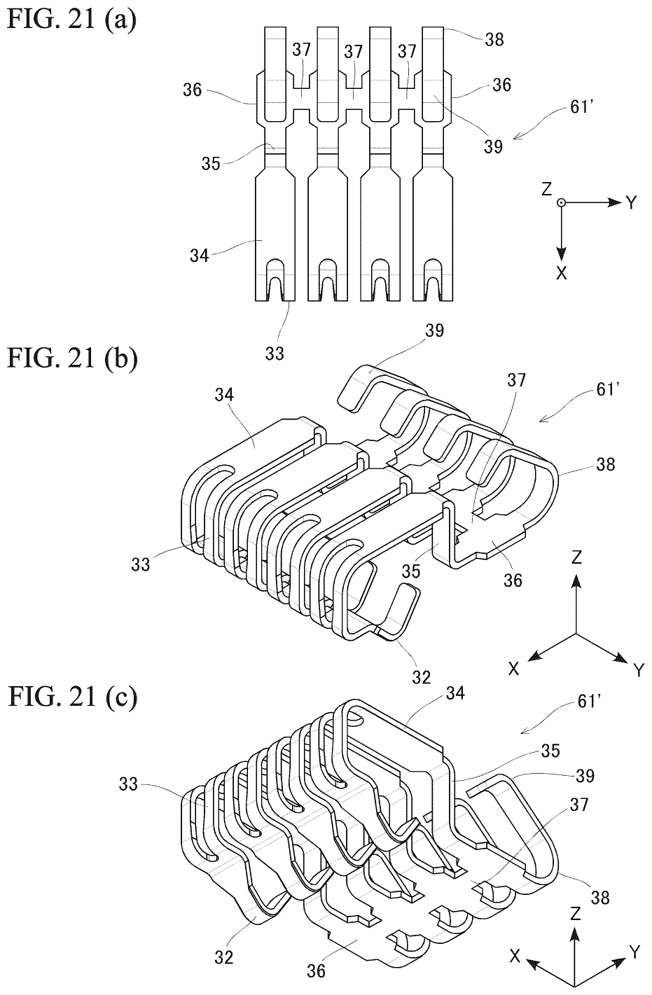

For example, as illustrated in FIGS. 11 and 12, the contacts 31 and the contact group 31′ of the present embodiment described above are formed by the contact portion 32 that is located at a lower position to make contact with the substrate 50 serving as an object to be connected, a spring shape portion 33 that is connected to the front of the contact portion 32 and is curved substantially in the form of a letter C in the front of the contact 31 in side view, a horizontal support portion 34 that is connected to the upper side of the spring shape portion 33 and is formed to extend horizontally toward the rear, a vertical fixing portion 35 that is connected to the rear end of the horizontal support portion 34, is vertically extended downward, and is embedded into the housing 21 made of resin, and the connection portion 36 that is connected to the lower end of the vertical fixing portion 35, is formed to extend horizontally to the rear, and is used for connecting the cable 15. However, the contacts and the contact group of the present invention are not limited to the configuration examples in FIGS. 11 and 12, and various modifications can be adopted. For example, as illustrated in FIGS. 20 and 21, a configuration can be adopted to include a second spring shape portion 38 that is connected to the rear of the connection portion 36 and is curved substantially in the form of a letter C in the rear of the contact 31 in right side view and a second contact portion 39 that is connected to the upper side of the second spring shape portion 38 and is formed to extend toward the front, in addition to the shapes of the contacts 31 and the contact group 31′ of the present embodiment. The second contact portion 39 is located in the upper part of the connector 20, protrudes with a spring property, and can be firmly brought into contact with an unshown substrate or the like that is pressed from above as an object to be connected. Also, for contacts 61 as a modification example in FIG. 20, the coupling portions 37 are provided at points having no spring property, for example, the points of the connection portions 36 to couple the plurality of contacts 61 as illustrated in FIG. 21, so that a contact group 61′ can be formed as the modification example. The connection portions 36 in the modification example illustrated in FIGS. 20 and 21 are portions serving as noncontact portions of the present invention. In the contacts of the present invention, the noncontact portions refer to portions that do not connect cables and have no spring property.

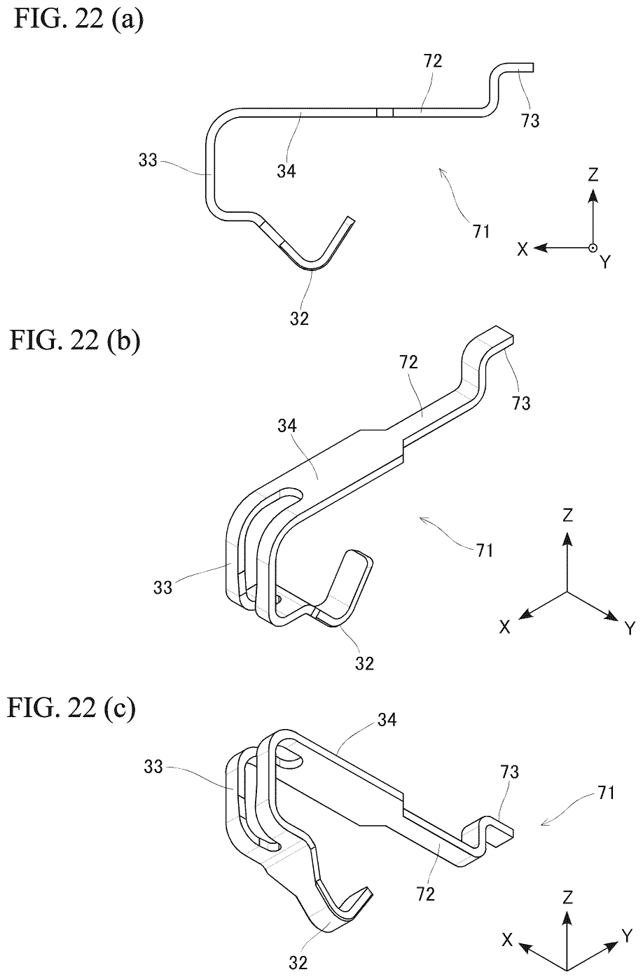

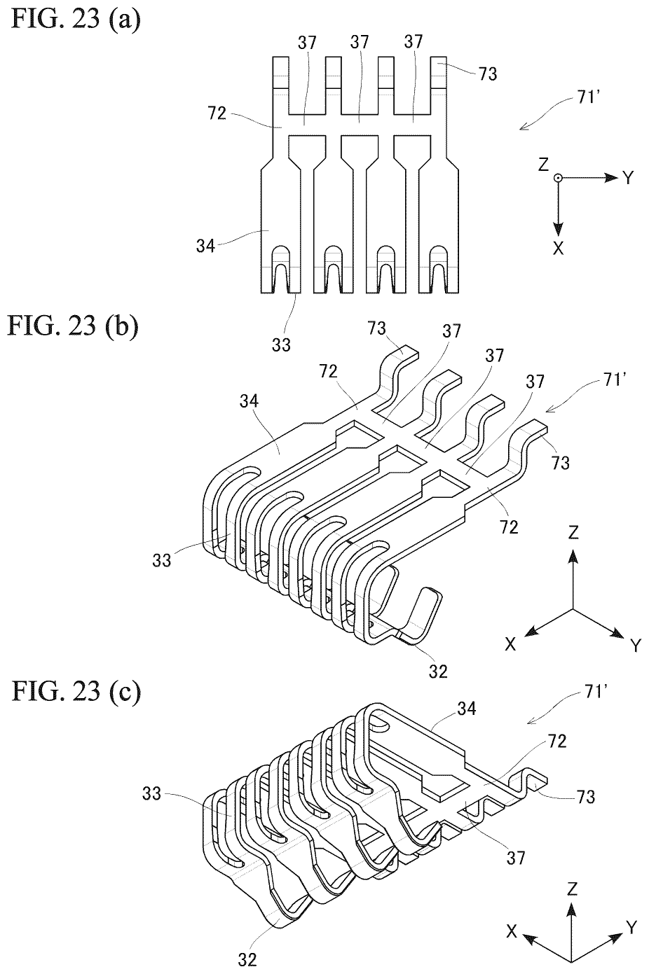

For example, for the contacts 31 and 61 and the contact groups 31′ and 61′ according to the present embodiment and the modification described above, another modification example can be illustrated. In other words, as illustrated in FIGS. 22 and 23, the contacts 71 and the contact group 71′ of another modification are formed by the contact portion 32 that is located at a lower position to make contact with the substrate 50 serving as an object to be connected, the spring shape portion 33 that is connected to the front of the contact portion 32 and is curved substantially in the form of a letter C in the front of the contact 31 in side view, the horizontal support portion 34 that is connected to the upper side of the spring shape portion 33 and is formed to extend horizontally toward the rear, a horizontal extension portion 72 as the noncontact portion of the present invention, the horizontal extension portion 72 being connected to the rear end of the horizontal support portion 34 and formed to extend horizontally toward the rear, and a soldering portion 73 that is connected to the rear of the horizontal extension portion 72, is formed to be bent in the shape of a letter L in side view, and is soldered to a substrate surface or the like. Also, for contacts 71 as another modification example in FIG. 22, the coupling portions 37 are provided at points having no spring property, for example, the points of the horizontal extension portions 72 serving as the noncontact portions of the present invention to couple the plurality of contacts 71 as illustrated in FIG. 23, so that a contact group 71′ can be formed as another modification example.

As is evident from the description of the claims, a configuration including such additional changes or modifications can be included in the technical scope of the present invention.

### REFERENCE SIGNS LIST

10 Connector cable
15 Cable
15a Signal cable
15b Power cable
20 Connector
21 Housing
22 Contact storage shape portion
23 Contact embedding groove
24 Mounting leg portion
31 Contact
31′ Contact group
31a Signal contact
31b Power supply contact
32 Contact portion
33 Spring shape portion
34 Horizontal support portion
35 Vertical fixing portion
36 Connection portion (noncontact portion in FIGS. 20 and 21)
37 Coupling portion
38 Second spring shape portion
39 Second contact portion
41 Shell
42 Cover shell
50 Substrate (object to be connected)
61 Contact
61′ Contact group
71 Contact
71′ Contact group
72 Horizontal extension portion (noncontact portion)
73 Soldering portion FIG. 13
(a): PRESENT EMBODIMENT
(b): COMPARATIVE EXAMPLE FIG. 14
(a): PRESENT EMBODIMENT
(b): COMPARATIVE EXAMPLE

1. A connector current capacity adjustment method for a compression type connector that is pressed against and connected to an object to be connected, comprising:
preparing the connector including
a housing made of resin, and
a plurality of contacts coupled with each other through at least one coupling portion and arranged in order while being partially embedded in the housing, each of the plurality of contacts including
a contact portion having a spring property for making contact with the object to be connected, and
a connection portion for connecting a cable without a spring property,
wherein the plurality of contacts includes signal contacts used for signal transmission and power supply contacts used for power supply, and the contact portion in each of the signal contacts and the power contacts has a width equal to each other,
the at least one coupling portion couples all or some of the power supply contacts, and
a current capacity is adjusted with maintaining a spring property of each of the power supply contacts by changing the number of the at least one coupling portions in the power supply contacts while keeping a shape of the contact portion having the spring property in each of the power supply contacts.

2. A compression type connector that is pressed against and connected to an object to be connected, comprising:
a housing made of resin, and
a plurality of contacts coupled with each other through at least one coupling portion and arranged in order while being partially embedded in the housing, each of the plurality of contacts incudes including a contact portion having a spring property for making contact with the object to be connected, and
a connection portion for connecting a cable without a spring property,
wherein the plurality of contacts includes signal contacts used for signal transmission and power supply contacts used for power supply, and the contact portion in each of the signal contacts and the power supply contacts has a width equal to each other,
the at least coupling portion couples all or some of the plurality of power supply contacts at points other than the contact portions in the power supply contacts, while keeping a shape of the contact portion having the spring property in each of the power supply contacts.

3. The connector according to claim 2, wherein the at least one coupling portion couples only the connection portions, each having no spring property, in the power supply contacts.

4. The connector according to claim 2, wherein the at least one coupling portion includes a plurality of coupling portions,
the power supply contacts includes a plurality of contact groups having the number of the plurality of coupling portions different from each other, and
the at least one coupling portion couples the connection portions, each having no spring property, in the power supply contacts.

5. The connector according to claim 2, wherein all contact portions, each having the spring property for making contact with the object to be connected, have shapes identical to each other.

6. A connector cable comprising:
the connector according to claim 1; and
a plurality of cables connected to the connection portions of the plurality of contacts provided in the connector.

7. The connector cable according to claim 6, wherein among the plurality of cables including signal cables connected to the signal contacts and power cables connected to the power supply contacts have different appearances.

8. The connector current capacity adjustment method according to claim 1, wherein each of the plurality of contacts includes a noncontact portion instead of the connection portion, the noncontact portion not connecting a cable and having no spring property, and
the current capacity is adjusted with maintaining a spring property of each of the power supply contacts by changing the number of the at least one coupling portions that couples the noncontact portions in the power supply contacts.

9. The connector according to claim 1, wherein each of the plurality of contacts includes a noncontact portion instead of the connection portion, the noncontact portion not connecting a cable and having no spring property, and
the at least one coupling portion couples the noncontact portions of the power supply contacts adjacent to each other.
